(19) United States
(12) Patent Application Publication
(10) Pub. No.: US 2021/0312491 A1
(43) Pub. Date: Oct. 7, 2021

(54) SYSTEM FOR THE SELECTIVE DISTRIBUTION OF PUBLICITY BY TELEMATIC MEANS

(71) Applicants: Ihar KUL, Vorsovia (PL); Alexander SHARAPOV, Minsk (BY); Katsiaryna SHUHAYEVA, CULLERA (ES)

(72) Inventors: Ihar KUL, Vorsovia (PL); Alexander SHARAPOV, Minsk (BY); Katsiaryna SHUHAYEVA, CULLERA (ES)

(21) Appl. No.: 16/925,097

(22) Filed: Jul. 9, 2020

(30) Foreign Application Priority Data
Apr. 7, 2020 (ES) P202030284

(51) Int. Cl. G06Q 30/02; G06F 16/29; G06F 16/9535; G06F 16/9537; H04L 29/08; G01S 19/01

(52) U.S. Cl. CPC G06Q 30/0236; G06F 16/29; G06Q 30/0267; G06Q 30/0261; G01S 19/01; G06F 16/9537; H04L 67/18; H04L 67/10; G06F 16/9535

(57) ABSTRACT

A system for the selective distribution of publicity by telematic means, consisting of a computer system comprising an array of computer applications distributed among a plurality of electronic devices (smartphones, portable computers and tablets, virtual vision glasses, etc. . . . ), of an array of advertisement generators (1), and of an array of advertisement recipients (2) who are potential customers, the system being connected via the internet (3) to an array of servers (4) and storage devices (5). The system comprises an advertisement-generator algorithm, which transfers a reward or prize from the advertisement generators (1) to the advertisement recipients (2) in exchange for viewing the publicity. The advertisements may be stored by the recipient and may be sent in accordance with GPS geolocation criteria (6) or that of other parameters.

The present invention advocates a system for the generation of publicity and its selective, impersonal distribution via electronic devices (smartphones, portable tablets and computers, virtual vision glasses, etc.) by means of resident applications, incorporating means for the generation of monetary reward for the users receiving the aforementioned publicity generated by the system.

For this reason, the object of the present invention will be of interest to the telecommunications sector and to the publicity industry in general.

### STATE OF THE ART

The publicity sent via the media connected to the internet has been developing in line with the increase in the use of data communications, particularly in line with the proliferation of the so-called “smartphones”, but in general via all types of connected devices, such as personal computers and smart tablets.

Mention should be made, among the background of the state of the art prior to the present invention, of the Patent WO 97/22074 PCT/US96/197311, entitled METHOD FOR TRADING CUSTOMER ATTENTION FOR ADVERTISEMENT, by the inventors A. Nathaniel Goldhaber and Gary Fitts, with a priority date in the year 1995.

Said patent discloses a new method of exploiting the internet publicity distribution business via a new commercial activity called “Attention Brokerage”. This would consist of the brokerage, the marketing of the attention paid by consumers to the publicity messages distributed via the Web.

Said brokerage would be performed via computerised means, enabling the advertisers to offer some type of compensation to the consumers for viewing their publicity.

Said compensation is called “negative priced”, as it is the advertiser who pays compensation to the public for viewing his advertisements. For this purpose, said target public is selected by the advertiser, once identified by his commercial strategy, and said target public must give their acceptance or permission to be sent the publicity.

Thus, advertisers may compete to purchase the attention of the consumers, which is tendered by the aforementioned “Attention Broker”.

The present invention advocates a system that ensures that both the publicity and the monies paid by the advertisers reach directly the potential customers. Therefore, the present invention is an improvement over currently existing systems, representing a step forward in the state of the art regarding the distribution and generation of publicity.

### DESCRIPTION

The present system for the selective distribution of publicity by telematic means represents an invention that enables the establishment of the means by which a customer can obtain money from the advertisers of goods and services, either distributed via the internet or by other telematic means, such as the sending of publicity messages by e-mail, by sms or by any other means via telecommunications operators.

In this way, with the present system for the selective distribution of publicity via telematic means, the advertisers must pay the potential customers for viewing their publicity.

The present invention advocates a system that ensures that both the publicity and the monies paid by the advertisers reach directly the potential customers.

Obviously, the advertisers must also pay the cost of using the system for the selective distribution of publicity via telematic means, for the service provided by the system owner.

In this way, the potential customers receive money from the advertising companies, as these pay, via this system for the selective distribution of publicity via telematic means, for the viewing of the advertisements or publicity content by said customers.

The receiving of the publicity is carried out via telematic means, either via the internet (sent via the websites visited), or via applications for mobile terminals such as smartphones and smart tablets.

The system comprises at least one (or several) multi-platform or multi-system applications with the following goal:
a) The generation and sending or presentation of different types of publicity messages; The configuration of parameters enabling an increase in the diversity of the characteristics of the publicity messages; The establishment of the levels of monetary reward for the users, to be determined by the advertising companies.
b) The receiving of publicity adjusted to the requirements of the moment, the situation or location, habits and lifestyle, psychological profile, and commercial interests and preferences of each user.

With the present system for the selective distribution of publicity by telematic means, two types of advertisement may be sent, namely: Static and Dynamic

By means of his authorisation, each user can accept the operation of the application and determine the minimum level of reward, in accordance with the volume and other characteristics of the publicity he allows to be sent, within the scope or capacity enabled by the system (Static and Dynamic advertisements).

In this way, the cost associated with the advertisements may be linked automatically with the mean of the values of the rewards established by the users for advertisements with similar characteristics in each specific area.

A Static advertisement may be formed by an image including pictures and text, displaying clearly the essence of the promotional content. The Static advertisement is stored in a specific section of the computer application in an advertisement catalogue (internal directory) linked to the application; once viewed by the user it cannot be deleted or eliminated during a period of time established by the system.

A Dynamic advertisement may also be formed by an image including pictures and text, displaying clearly the essence of the promotional content. However, once viewed by the user, the dynamic advertisement is deleted or eliminated from the computer application of the recipient, unless said recipient decides to retain the same.

Thus, the advertiser can reward the potential consumer of his products, goods or services, regardless of the decision of the consumer concerning the use of the commercial offer in each of the advertisements.

On the other hand, the present system for the selective distribution of publicity by telematic means has certain capabilities to aid the advertisers in the selection of their target public, thus optimising their marketing campaigns.

In order to obtain the aforementioned rewards from the advertising companies, the potential customers must first register in the system, a process during which they will have to provide certain information, which is stored in a database of the same and which will subsequently be used for the selection of potential customers in accordance with the marketing strategy that each advertising company wishes to follow.

For this reason, the system comprises two methods of selection of potential customers for the publicity-sending process. The first is to select said customers from the aforementioned database generated during the process of registration in the application of the system. Said database may contain information of a private nature and concerning consumer needs. The customers may be individuals or legal entities. Thus, for example, regarding individuals, information regarding their place of residence, age, interests, consumer tastes, service requirements, etc. may be registered, and for legal entities, their business address, activity sector, company size, etc. . . . highly useful in the selection of the target public, in the performance of marketing campaigns, for all types of goods and services.

However, notwithstanding the above, the system may also draw from other external databases for the generation of the addresses of potential target public in order to contact them, to obtain new customers and thus to increase the number of customers registered in the system.

The second method of selection of potential customers by means of the present system for the selective distribution of publicity by telematic means consists of discriminating the above by means of their geolocation. To do this, said potential customers must have authorised the system, via the application employed, to access their geolocation.

Most of the aforementioned electronic communication devices, i.e. the aforementioned mobile terminals such as smartphones and tablets or computers, have the ability to provide their location to applications authorised by the user thereof, in such a way that in this case, the system may obtain said information via the application functioning in each of these devices.

Thus, marketing strategies may be followed by selecting customers in a specific zone or area. For example, the sending of a specific advertisement to customers who may be within a certain radius of a store, determined by the coordinates thereof. Thus, all the potential customers who, at a particular time, are within a distance of (e.g.) 500 metres would receive a publicity message, which might be an offer of their interest at that time, due to their proximity, while other customers who are further away would not be part of that target public for that advertisement at that particular time, as the advertiser might consider it highly improbable that other customers would go to that location from a distance greater than 500 metres to make a purchase.

Thus, in this case, the target group for the publicity comprises the spontaneous consumers of goods and services who might be at a particular location at a particular moment in time.

### PREFERRED EMBODIMENT OF THE INVENTION

A detailed description of the system for the selective distribution of publicity by telematic means is to be found below, with reference to the accompanying drawings wherein, by way of a non-limiting example, a preferred embodiment of the invention is portrayed, which is susceptible to any variations in detail which do not represent a fundamental variation of the essential characteristics of said developments.

These drawings illustrate:

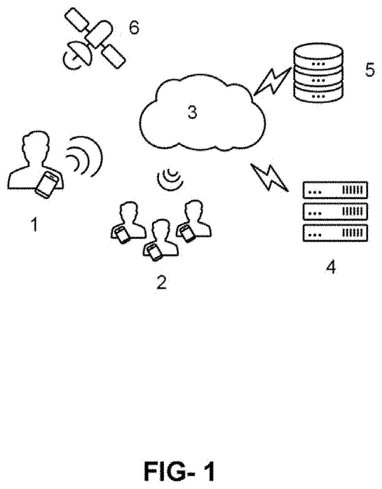

In FIG. 1: A schematic view of the architecture of the system for the selective distribution of publicity by telematic means.

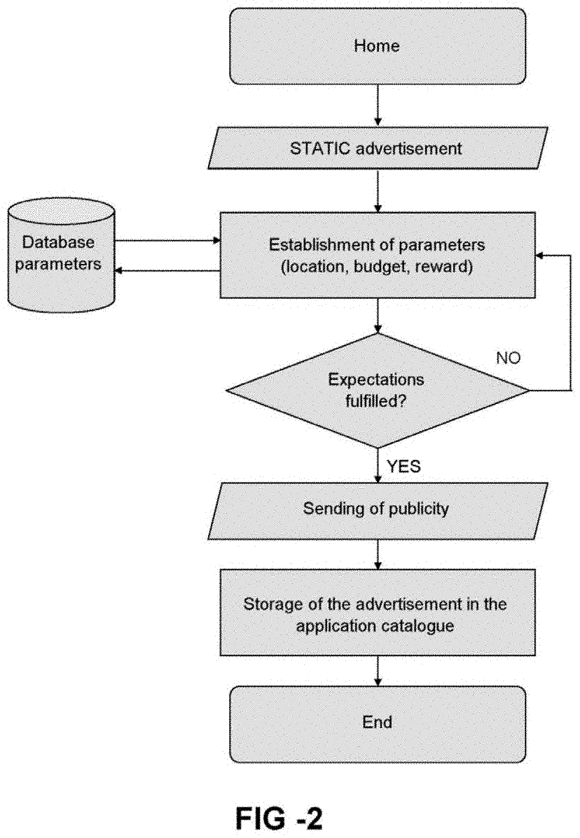

In FIG. 2: A view of the process of the Algorithm for the generation of static advertisements of the system for the selective distribution of publicity by telematic means.

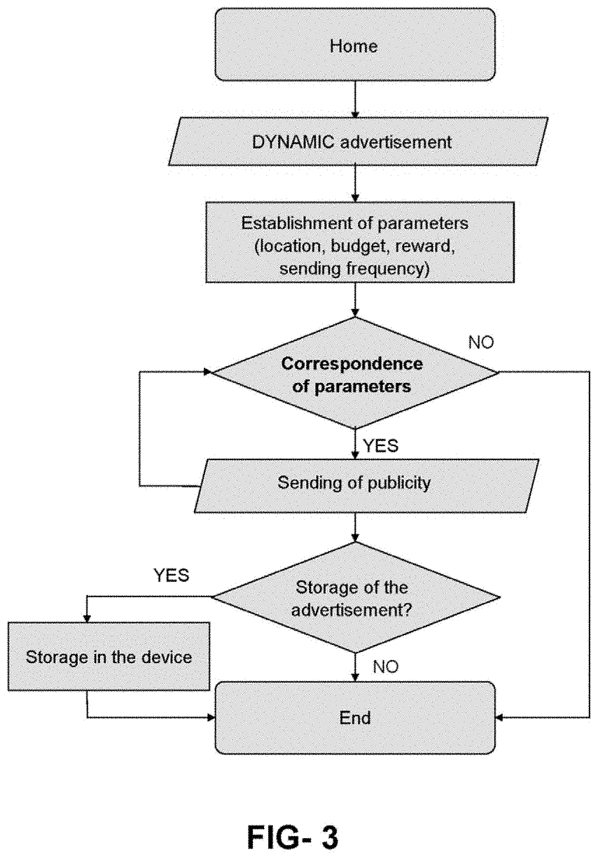

In FIG. 3: A view of the process of the Algorithm for the generation of dynamic advertisements of the system for the selective distribution of publicity by telematic means.

In accordance with the example portrayed, the system for the selective distribution of publicity by telematic means illustrated in this preferred embodiment consists fundamentally of a computer system comprising a set of computer applications distributed among a plurality of electronic devices (smartphones, portable computers and tablets, virtual vision glasses, etc. . . . ) by an array of advertisement generators (1) for the issuing and sending of advertisements, and an array of advertisement recipients (2) who are potential customers and recipients of advertisements, the system being connected to said electronic devices via the internet (3) and in turn to servers or computers (4) connected to the Web, and storage devices (5). In the system described, the aforementioned applications distributed via electronic devices are multi-platform or multi-system applications, in order that they may function with all types of device existing on the market, the system connecting certain advertisement generators (1) directly to certain advertisement recipients (2) by means of a certain advertisement-generator algorithm, which transfers a reward or prize from the advertisement generators (1) to the advertisement recipients (2) in exchange for viewing the publicity.

Likewise, the system comprises two types of advertisement-generator algorithms, one algorithm for the generation of static advertisements and the other for the generation of dynamic advertisements, where the advertisements are formed by an image including pictures and text, displaying clearly the essence of the promotional content, the static advertisements being stored in a particular section of the computer application of each advertisement recipient (2) in a catalogue of advertisements linked to said application; once viewed by the advertisement recipient (2) they cannot be deleted or eliminated during a period of time established by the system; while dynamic advertisements, once viewed by the advertisement recipient (2), are deleted or eliminated from the computer application, unless said advertisement recipient (2) should decide to retain the same, programming its preservation in the application.

On the other hand, the computer applications of the advertisement recipients (2) comprise a registration algorithm which captures data of a private nature and on consumer needs, which are stored in a database in the aforementioned storage devices (5). Said information may comprise data of individuals or legal entities. Thus, for example, regarding individuals, information regarding their place of residence, age, interests, consumer tastes, service requirements, etc. may be registered, and for legal entities, their business address, activity sector, company size, etc. . . . highly useful in the selection of the target public, in the performance of marketing campaigns, for all types of goods and services.

Furthermore, with the authorisation of the administrator of the electronic device, the computer applications of the advertisement recipients (2), may also capture geolocation data via GPS (6) or other system provided by the communications operator to which they are connected.

In addition to the above, the system comprises an algorithm for the sending of advertisements to advertisement recipients (2) within a certain radius of certain particular coordinates.

Thus, marketing strategies may be followed by selecting customers in a specific zone or area. For example, the sending of a specific advertisement to customers who may be within a certain radius of a store, determined by the coordinates thereof. Thus, all the potential customers who, at a particular time, are within a distance of (e.g.) 500 metres would receive a publicity message, which might be an offer of their interest at that time, due to their proximity, while other customers who are further away would not be part of that target public for that advertisement at that particular time, as the advertiser might consider it highly improbable that other customers would go to that location from a distance greater than 500 metres to make a purchase.

In fact, the present system may be used by any advertiser; for example, a restaurant that wishes to send an advertisement saying “Today, between 3:00 p.m. and 7:00 p.m. we are offering a 50% discount on all the dishes on the menu”, and it chooses as target public the users of the application within a range of 900 metres. This means that it is not necessary for the advertiser to sell his goods and services telematically but may do so offline. For example: physical stores, dry-cleaners, hairdressers, hotels, veterinarians, beauty salons, etc.

Finally, the system connects to external databases for the generation of the addresses of potential advertisement recipients (2) or target public, in order to connect with and capture new customers and to increase the number of customers registered in the system.

And lastly, the shape, materials and dimensions may be variable, as may, in general, everything that is accessory and secondary, provided that it does not alter or modify the essential nature of the improvements described herein.

1. A system for the selective distribution of publicity via telematic means, consisting of a computer system comprising an array of computer applications distributed among a plurality of electronic devices (smartphones, portable computers and tablets, virtual vision glasses, etc.), an array of advertisement generators (1) for the issue and sending of advertisements, and an array of advertisement recipients (2) who are potential customers and recipients of advertisements, the system being connected to said electronic devices via the internet (3) and in turn to an array of servers or computers (4) connected to the Web, and storage devices (5), characterised in that the aforementioned computer applications distributed by means of electronic devices are multi-platform or multi-system applications, the system connecting certain advertisement generators (1) directly to certain advertisement recipients (2) by means of a specific advertisement-generator algorithm, which transfers a reward or prize from the advertisement generators (1) to the advertisement recipients (2) in exchange for viewing the publicity.

2. A system for the selective distribution of publicity via telematic means, as claimed in claim 1, characterised in that the system comprises two types of advertisement-generator algorithms, one algorithm for the generation of static advertisements and the other for the generation of dynamic advertisements, where the advertisements are formed by an image including pictures and text, the static advertisements being stored in a particular section of the computer application of each advertisement recipient (2) in a catalogue of advertisements linked to said application; once viewed by the advertisement recipient (2) they cannot be deleted or eliminated during a period of time established by the system; while dynamic advertisements, once viewed by the advertisement recipient (2), are deleted or eliminated from the computer application, unless the advertisement recipient (2) should program their preservation.

3. A system for the selective distribution of publicity via telematic means, as claimed in claim 1, characterised in that the computer applications of the advertisement recipients (2) comprise a registration algorithm which captures data of a private nature and on consumer needs, which are stored in a database in the aforementioned storage devices (5).

4. A system for the selective distribution of publicity via telematic means, as claimed in claim 1, characterised in that with the authorisation of the administrator of the electronic device, the computer applications of the advertisement recipients (2), may also capture geolocation data via GPS (6) or other system provided by the communications operator to which they are connected.

5. A system for the selective distribution of publicity via telematic means, as claimed in claim 1, characterised in that the system comprises an algorithm for the sending of advertisements to advertisement recipients (2) located within a certain radius of certain particular coordinates.

6. A system for the selective distribution of publicity via telematic means, as claimed in claim 1, characterised in that the system connects to external databases for the generation of the addresses of potential advertisement recipients (2).
